(19) United States
(12) Patent Application Publication
(10) Pub. No.: US 2024/0300838 A1
(43) Pub. Date: Sep. 12, 2024

(54) BUFFER TANK SEPARATION AND HOMOGENIZATION SYSTEM

(71) Applicant: Georgia Tech Research Corporation, Atlanta, GA (US)

(72) Inventors: Shannon YEE, Decatur, GA (US); David HASLER, Zurich (CH); Roland LEHMANN, Gossau (CH); Christian SEILER, Herisau (CH); Christian FORRER, Degersheim (CH); Christoph FARRÉR, Effretikon (CH); Andreas STAUB, Hettlingen (CH); Marco CADUFF, Wil (CH); Janine GLATTHARD, Wil (CH); Mathias SCHLAURI, Wil (CH); Adrian GEMPERLI, Wil (CH); Florian FISCHER, Wil (CH); Daniel RÜDISÜLI, Wil (CH); Valdinei FRASSON, Wil (CH)

(21) Appl. No.: 18/578,225

(22) PCT Filed: Jul. 15, 2022
(86) PCT No.: PCT/US2022/037396

§ 371 Date: Jan. 10, 2024

Related U.S. Application Data
(60) Provisional application No. 63/222,726, filed on Jul. 16, 2021.

(51) Int. Cl. C02F 11/123; C02F 1/00; C02F 103/00

(52) U.S. Cl. CPC C02F 11/123; C02F 1/00; C02F 2001/007; C02F 2103/005; C02F 2201/008

(57) ABSTRACT

System and method for buffer tank separation and homogenization are described. The system can include a belt separator (104), a liquids collection tank (106), a solids collection tank (108), and a homogenizer (110). The belt separator comprising a perforated belt looped between two rollers, the belt separator positioned to receive an input comprising at least one of: solids and liquids, the input received via the at least one inlet onto the belt of the belt separator, the belt separator configured to deliver a solids portion of the input to the solids collection tanks and to deliver the liquids portion of the input to the liquids collection tank; and a homogenizer connected to the solids outlet, the homogenizer configured to receive a collected solids portion output and form a uniform and homogenized slurry.

### CROSS-REFERENCE TO RELATED APPLICATION

This application claims the benefit of and priority to U.S. Provisional Application No. 63/222,726, titled “BUFFER TANK SEPARATION AND HOMOGENIZATION SYSTEM,” filed on Jul. 16, 2021, the entire contents of which are hereby incorporated herein by reference.

### BACKGROUND

An estimated 4.5 billion people worldwide do not have access to safe, affordable sanitation systems. High levels of child death and disease have been linked to oral fecal contamination where pathogen laden fecal matter enters the food or water supply. Non-sewered sanitation systems are needed where traditional sanitary sewer systems are unavailable or impractical.

### SUMMARY

Disclosed herein is a buffer tank separation system comprising at least one inlet, a liquids collection tank comprising a liquids outlet, a solids collection tank comprising a solids outlet, a belt separator, and a homogenizer.

The belt separator comprises a perforated belt looped between rollers and is positioned to receive an input stream via the at least one inlet onto the belt of the belt separator. The input stream comprises at least one of solids and liquids and is configured to deliver a solids portion of the input stream to the solids collection tank and to deliver the liquids portion of the input stream to the liquids collection tank.

The homogenizer is connected to the solids outlet and is configured to receive a collected solids portion out put and form a uniform and homogenized slurry.

Also disclosed are methods for separating human waste using the disclosed buffer tank separation system.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates an example schematic diagram of a buffer tank separation and homogenization system according to various embodiments described herein.

FIGS. 2A-2C illustrate perspective and side views of an example belt separator for the buffer tank separation and homogenization system of FIG. 1 according to various embodiments described herein.

FIG. 3 illustrates an example buffer tank separation and homogenization system of FIG. 1 according to various embodiments described herein.

FIG. 4 illustrates cross-sectional view of the buffer tank separation and homogenization system of FIG. 3 according to various embodiments described herein.

FIG. 5 illustrates an example method for using a buffer tank separation and homogenization according to various embodiments described herein.

FIGS. 6A-6D illustrate example flow and separation for various waste events using the buffer tank separation and homogenization system according to various embodiments described herein.

FIG. 7 illustrates one example schematic of a buffer tank separation and homogenization system used as a module within a non-sewered single unit toilet system according to various embodiments described herein.

FIG. 8 illustrates another example schematic of a buffer tank separation and homogenization system used as a module within a non-sewered single unit toilet system according to various embodiments described herein.

### DETAILED DESCRIPTION

Sanitation systems are needed for regions of the world where open defecation or lack of improved sanitation is common, which can lead to illness. Traditional sewage and wastewater treatment plants which receive waste from sewers can be expensive to implement and operate. Technologies for multi-unit toilets are being developed to process waste on a large scale. However, there is a need for technology to provide access to safe, affordable sanitation systems that can be deployed in a family home without sewer connections. Holistically, as water scarcity rises across the globe, sanitation systems that reduce reliance on large volumes of water for transport of waste over long distances will become increasingly important, not just in developing countries, but globally.

To address these deficiencies, systems for use in a stand-alone non-sewered toilet system are discussed herein. The systems can be configured to inactivate pathogens from human waste and prepare the waste for safe disposal. The systems can also recover valuable resources such as clean water. The systems can be configured to operate without connection to input water or output sewers. Some example systems can be battery based or powered by off-grid renewables. The systems can be optimized for low-cost fabrication and low operation costs. The systems can promote sustainable sanitation services that operate in poor, urban settings, as well as in developed and developing nations.

The ISO 30500 standard provides a technical standard for non-sewered sanitation systems designed to address basic sanitation needs and promote economic, social, and environmental sustainability through strategies that include minimizing water and energy consumption, and converting human excreta to safe output. These sanitation systems are intended to operate without connection to any sewer or drainage network and meet health and environmental safety and regulatory parameters. In some examples, systems described herein can be configured to provide treated output that meets or exceeds the ISO 30500 standard.

For example, human waste streams can include urine, feces, diarrhea, and the like. Sanitation incidentals can include toilet paper, feminine hygiene waste, diapers, other paper products, and the like. In some toilet systems, a portion of sanitation incidentals, including non-organic products such as diapers, can be received and processed separately from the human waste streams. In some examples, the wastes streams comprise human feces and urine, menstrual blood, bile, flushing water, anal cleansing water, toilet paper, other bodily fluids and/or solids. Additionally, the waste streams can comprise water, including flush water, rinse water, wash water, fresh water, consumable water, potable water, useable water, and the like.

For example, a stand-alone non-sewered toilet system can comprise a liquid treatment system and a solids treatment system, each of which can operate as a separate system or be interconnected for treatment of human waste. The stand-alone non-sewered toilet system can also comprise at least one separation system. In some examples, the content of human waste streams can be separated or processed separately. Separation of streams can provide more efficient processing than mixed-content human waste streams by dividing the source material into primarily feces, urine, and wastewater streams. Since 100% separation is not practical, a degree of cross contamination between the streams is acceptable for the subsequent downstream treatment approaches. As described herein, the feces stream, containing primarily feces, is also referred to as the “brown stream.” The brown stream is mostly feces, but can also be mixed with other liquid and solid waste. For example, the brown stream can include feces, toilet paper, some urine, and some water. As described herein, the “green stream” can include mostly water, some urine, and some toilet paper, and usually does not include feces. The green stream is mostly liquid with some solids. As described herein, the urine stream, containing primarily urine, is also referred to as the “yellow stream.” For example, a yellow stream can include urine and some water. As described herein, the wastewater stream is also referred to as the “blue stream.” For example, the blue stream can contain primarily wastewater in the form of flush water, anal rinse water, or excess water that is poured into the toilet. In some examples, the blue stream can also include some urine. Stream separation can enable lower cost and more robust treatment processes given the high degree of variability in low volume fecal deposits (recognized as primarily diarrhea), high volume urine deposits, and excessive amounts of flush and anal rinse water, given future water scarcity constraints.

In the context described above, various examples of buffer tank separation and homogenization systems and methods are described herein. The buffer tank separation and homogenization system can be a separation system that can operate separately or can be configured to integrate with another system. For example, the buffer tank separation and homogenization system can be a separation system configured for use in a stand-alone non-sewered toilet system. For example, the buffer tank separation and homogenization system can be integrated as a module for separating, clarifying, and homogenizing human waste in a stand-alone non-sewered sanitation system. In some examples, the buffer tank separation and homogenization system can be configured to operate as part of a single unit toilet system. For example, the buffer tank separation and homogenization system can be integrated for use in a single unit toilet system configured to render the bodily wastes of an adult human into water, CO₂, and mineral ash. For example, the stand-alone non-sewered sanitation system can also include a urine and wastewater treatment system and a feces treatment system.

The buffer tank separation and homogenization system can be used receive and separate a green stream and a brown stream to further separate the solids and liquids of the green and brown stream. The buffer tank separation and homogenization system can clarify the green stream by removing solids. For example, the clarified green stream can be part of a liquids output of the system that can be routed to a urine and wastewater treatment system for filtering to produce useable water. The buffer tank separation and homogenization system can remove excess liquid from the brown stream to produce a brown slurry to be delivered to a feces treatment system for removal or destruction of pathogens.

The buffer tank separation and homogenization system can be a dual chamber tank system for the short-term storage and fractional passive separation of liquid from solid human waste and toilet paper. The system can be connected to a homogenization component that macerates the solid waste to a uniform particle size and transports the slurry to a feces treatment system. The buffer tank separation and homogenization system can operate as a part of a single unit toilet system. The buffer tank separation and homogenization system can receive at least one input and produce at least two outputs that can be delivered separately for further treatment. For example, at least one input stream can be received into the buffer tank separation and homogenization system from a frontend unit that collects and separates a mixed waste. In an example, the frontend unit can deliver a green stream and a brown stream. In some examples, the frontend unit can deliver a green stream, a brown stream, and a yellow stream. A green stream, comprising primarily of urine, flush water and toilet paper can be delivered to a liquids tank or “green tank” and a brown stream, comprising of a mixture of feces, urine, flush water and toilet paper can be delivered to a solids tank or “brown tank”. It is noted that the yellow, green, and brown streams are defined by the composition of human waste, as described herein, not by the actual color of the physical stream. Similarly, the liquids tank and the solids tank can contain both liquids and solids. The output from the liquids tank can be delivered to a liquid treatment system for removal or destruction of pathogens or contaminants to produce usable water. The output from the solids tank can be delivered to a solids treatment system for removal or destruction of pathogens or contaminants to produce inert material output.

The buffer tank separation and homogenization system can include a mechanism to separate and deliver the solid toilet paper from the green stream to the solids tank and the liquids from the brown stream to the liquids tank. Further, in some examples, the system can receive a yellow stream from the frontend unit that collects and separates a mixed waste. Additionally, when integrated with other systems, recirculation input streams can be received into the buffer tank separation and homogenization system. For example, a filter concentrate can be received from a urine and wastewater treatment system and a liquid effluent can be received from a feces treatment system for further processing.

The primary output streams from the buffer tank separation and homogenization system are a collected liquids stream and a collected solids slurry. The collected solids or “brown” slurry can comprise feces, flush water, toilet paper and urine. A homogenizer, similar in design and operation to a bladed macerator, can be used to transform the collected solids output in the solids tank into a uniform and homogenized slurry for transport to the treatment modules. In some examples, the homogenizer can be incorporated into the solids tank design. The brown slurry can be delivered to a feces or solids treatment system. The liquid effluent or collected liquids from the liquids tank can be pumped from the liquids tank to a urine and wastewater treatment system and can comprise urine, flush water, and trace amounts of toilet paper or other solids.

In the following discussion, a general description of the buffer tank separation and homogenization system and components is provided, including a discussion of the operation of the same. Non-limiting examples of a buffer tank separation and homogenization system are discussed. In some examples, the configuration can include optional connections to integrate the buffer tank separation and homogenization system with other systems. For example, the buffer tank separation and homogenization system can integrate with a stand-alone non-sewered sanitation system comprising a urine and wastewater treatment system and/or a feces treatment system. In some examples, the buffer tank separation and homogenization system can be a module of an ISO 30500 compliant toilet system.

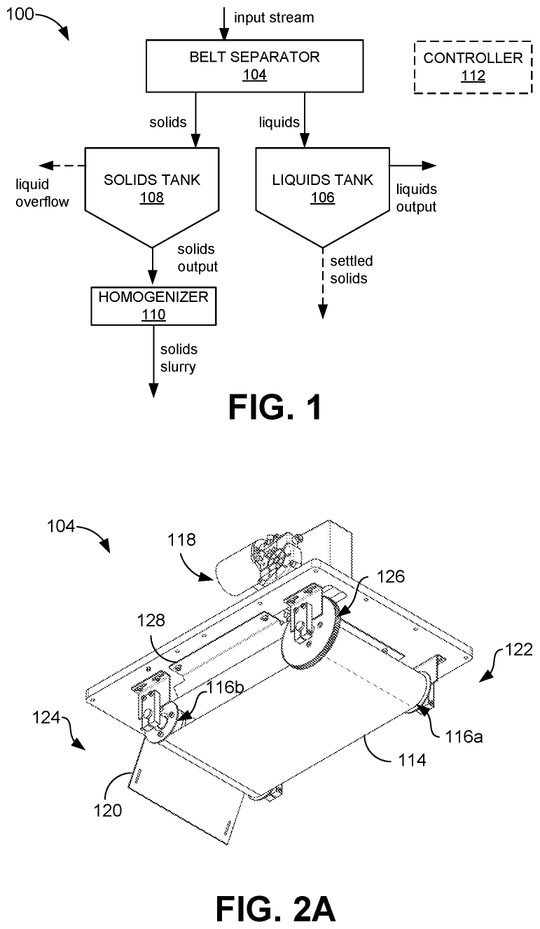

FIG. 1 illustrates an example diagram of the buffer tank separation and homogenization system 100. The buffer tank separation and homogenization system 100 can include a belt separator 104, a liquids tank 106, a solids tank 108, and a homogenizer 110. The input stream can be at least one input stream comprising liquids and/or solids and received via at least one inlet. The buffer tank separation and homogenization system 100 can be used receive and separate an input stream of human waste into a solids portion delivered to a solids tank 108 and a liquids portion delivered to a liquids tank 106. The solids tank 108 can contain some liquids and the liquids tank 106 can contain some solids. In each of the liquids tank and solids tank, the solids are separated from the liquids by sedimentation. A liquids output from the liquids tank 106 can be directed for further processing. For example, the liquid effluent from the liquids tank can be a liquids output pumped from the liquids tank to a urine and wastewater treatment system. The settled solids in the liquids tank 106 can be removed and/or redirected as an additional input stream to the buffer tank separation and homogenization system 100. The solids output from the solids tank 108 can be directed for further processing. For example, the solids output can be received into a homogenizer 110 to produce a slurry of solids or feces slurry delivered to a feces or solids treatment system. A liquid overflow from the solids tank 108 can be removed and/or redirected as an additional input stream to the buffer tank separation and homogenization system 100. The buffer tank separation and homogenization system 100 can also include a controller 112 comprising a processor and memory and configured to operate the belt separator 104 as well as other sensors, valves, actuators, motors, and pumps not shown.

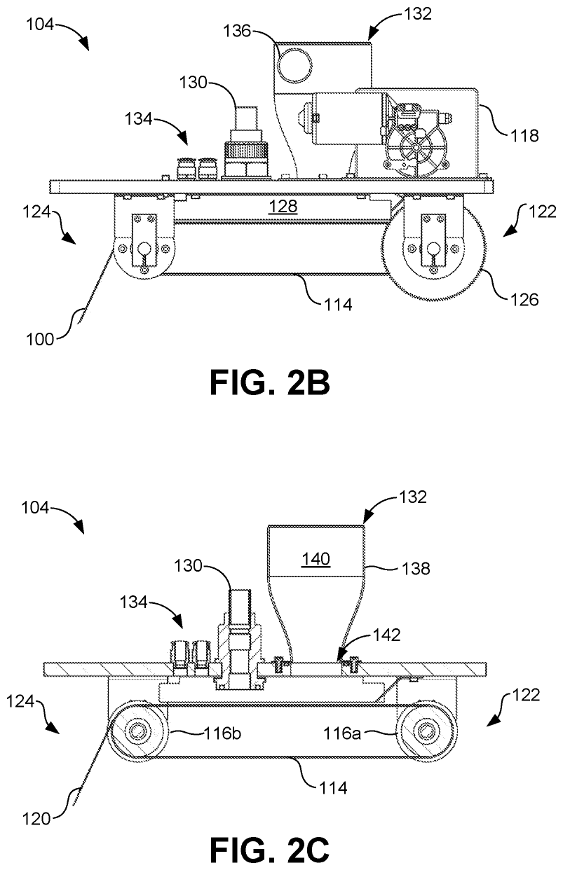

Shown in FIGS. 2A-2C are bottom, front, and cross-sectional views of the belt separator 104 of the buffer tank separation and homogenization system 100. The belt separator 104 can comprise a perforated belt 114 looped between two rollers 116a, 116b and driven by a motor 118. The belt separator 104 can be positioned to receive an input stream via at least one inlet onto the perforated belt 114 of the belt separator 104. The perforated belt 114 of the belt separator 104 can comprise pores (not shown) configured to allow the liquids portion of the input stream to pass through the perforated belt 114 to the liquids tank 106 and to retain the solids portion on the perforated belt 114. The perforated belt 114 can convey the retained solids toward a scraper or squeegee 120 configured to remove the solids from the perforated belt 114 and direct the solids to the solids tank 108. For example, the perforated belt 114 looped between the two rollers 116a, 116b can be driven at a first end 122 of the belt separator 104 by the motor 118 turning a drive wheel or gear 126 connected to a first roller 116a, with the scraper or squeegee 120 can be positioned at the second end 124. A splash shield 128 can be positioned laterally on both sides of the perforated belt 114, extending at least partially between the first and second ends 122, 124, and configured to direct the at least one input onto the perforated belt 114 such that the solids are also retained on the perforated belt 114.

The buffer tank separation and homogenization system 100 can receive at least one input stream onto the belt separator 104 via at least one inlet. As shown in FIGS. 2B and 2C, an example buffer tank separation and homogenization system 100 can have individual inlets configured to receive individual ones of the at least one input stream. For example, the individual inlets can be configured for the volume, pressure, flow velocity, and/or expected solids content of the individual input streams of the at least one input stream. For example, the buffer tank separation and homogenization system 100 can comprise a first inlet 130 configured to receive a mostly liquids input, a second inlet 132 configured to receive a mostly solids input, and optionally one or more auxiliary inlets 134 to receive other input streams. For example, the buffer tank separation and homogenization system can include one or more auxiliary inlets 134 configured to receive at least one of: a diverted urine stream, a sludge stream received from a liquids collection tank, an overflow stream received from a solids collection tank, a reject stream received from a liquids treatment system, a filtrate received from a feces treatment system, and a condensed effluent received from a feces treatment system.

For example, the buffer tank separation and homogenization system 100 can receive a green stream and a brown stream, separately, as two input streams onto a perforated belt 114 of the belt separator 104. The belt separator 104 of buffer tank separation and homogenization system 100 can separate and deliver the solid toilet paper from the green stream to the solids tank and the liquids from the brown stream to the liquids tank. For example, the mostly liquids input stream can be received via a first inlet 130 at a different flow velocity than the mostly solids input stream comprising feces received via a second inlet 132. The second inlet 132 can be configured to receive the mostly solids input stream, having a large solids content, can be delivered under pressure and/or at a high flow velocity, as such the second inlet can be configured to slow the flow velocity as the mostly solids input stream is received. In some examples, the mostly solids stream can be delivered to the buffer tank separation and homogenization system 100 under pressure. The second inlet 132 can comprise an offset chamber inlet 136, an inlet chamber 138 having an interior wall surface 140, and a chamber outlet 142. The second inlet 132 can be configured receive the mostly solids input stream via the offset chamber inlet 136, direct the input stream toward an interior wall surface 140 of the inlet chamber 138 to flow out the chamber outlet 142 onto a perforated belt 114 of the belt separator 104.

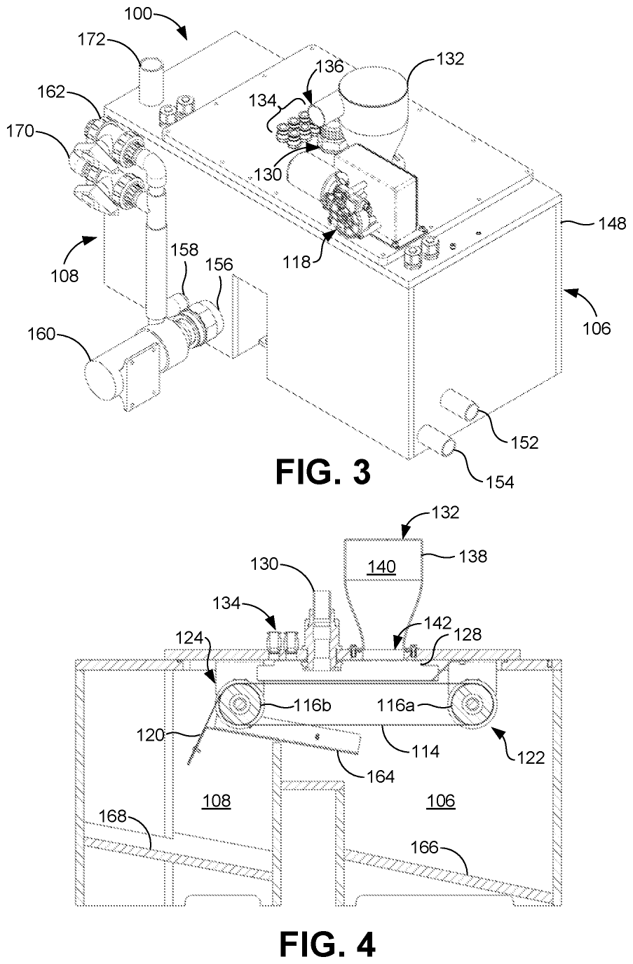

FIGS. 3 and 4 show an example buffer tank separation and homogenization system 100 in greater detail. As shown, the belt separator of FIGS. 2A-2C is secured to a dual chamber enclosure 148. FIG. 4 illustrates a cross-section of the buffer tank separation and homogenization system 100 of FIG. 3. As shown in FIG. 3, a liquids tank 106 and a solids tank 108 are chambers within the enclosure and positioned beneath the belt separator 104. As shown in FIG. 3, the liquids tank 106 includes a liquids tank outlet 152 and a sludge outlet 154. The solids tank 108 includes a solids tank outlet 156 and a recirculation outlet 158. The settled solids output within the solids tank 108 can be routed to the macerator 160 attached to the solids tank outlet 156 so that a uniform feces slurry can be formed. For example, the macerator 160 can be the homogenizer 110, as described herein. The slurry from the macerator 160 can be directed to a feces treatment system via the solids system outlet 162. In some examples, a portion of the contents of the solids tank 108 can also be routed for recirculation via the recirculation outlet 158. The output from the solids tank can be recirculated to the solids tank 108 via recirculation outlet 158. The buffer tank separation and homogenization system 100 can also include a bypass 170 for overflow or circulation of the solids tank 208, where the flow and pressure are adjustable. Additionally, when integrated with other systems such as a urine and wastewater treatment system and/or a feces treatment system liquid portions containing solids, such as filtrate, condensed effluent, and/or filter reject, can be received as input streams for further processing via one or more auxiliary inlets 134.

Illustrated in FIG. 4 is a cross-sectional view of an example buffer tank separation and homogenization system 100. The buffer tank separation and homogenization system 100 can include the belt separator 104, a liquids tank 106, and a solids tank 108. In this example, the liquids tank 106 and the solids tank 108 are chambers contained within the same dual chamber enclosure 148, although the design can be implemented and relied upon in other configurations such as physically separate tanks. In this example, the belt separator 104 is positioned above a portion of the liquids tank 106 and a portion of the solids tank 108 and is configured to receive an input stream from the first inlet 130, the second inlet 132, or an individual one of the plurality of auxiliary inlets 134 onto the perforated belt 114. A liquid portion of the input stream can flow by gravity into the liquids tank 106. A solids portion of the input stream can be conveyed by the moving perforated belt 114 towards the solids tank 108. A scraper or squeegee 120 can be positioned at the second end 124 of the belt separator 104 and configured to remove solids from the moving perforated belt 114. A liquid deflector 164 can be position beneath the second end 124 of the belt separator 104 to capture and channel liquids to the liquids tank 106 as the solids are removed from the perforated belt 114 or liquids received onto the perforated belt 114 that flow toward the second end 124.

The liquids tank 106 is configured to clarify the fluids received by allowing solid particles to settle. In some examples, the liquids tank 106 can include a bottom wall 166 inserted into the liquids tank 106 or formed in the body of the liquids tank 106. The bottom wall 166 can be angled or shaped to direct a sludge of the settled solids to a sludge outlet 154. In an example, a sludge stream of settled solids can be delivered to the belt separator 104 to remove any liquid content and direct the solids to the solids tank 108. In another example, the settled solids can be delivered directly to the solids tank 108. A clarified liquid stream can be released via a liquids tank outlet 152. The liquids tank 106 can also include a baffle or weir (not shown) to help reduce the number of particulates that enter the liquids tank outlet 152. In an example, the clarified liquid stream output can be released natural overflow. In another example, the clarified liquid stream output can be released via a valve system or pumped. For example, the clarified liquid stream output can be delivered to a urine and wastewater treatment system.

The solids tank 108 is configured to receive solids separated by the belt separator 104 and to allow solid particles to settle and extract liquids. In some examples, the solids tank 108 can include a bottom wall 168 inserted into the solids tank 108 or formed in the body of the solids tank 108. The bottom wall 168 can be angled or shaped to direct the settled solids to the solids tank outlet 156. The solids tank outlet 156 is connected to a homogenizer 110 configured to mix, grind, or macerate the settled solids from the solids tank 108 to a slurry that can be delivered from the buffer tank separation and homogenization system 100 and transported to a feces treatment system for removal of pathogens. The buffer tank separation and homogenization system 100 can also include a bypass 170 (FIG. 3) for overflow or circulation of the solids tank 108, where the flow and pressure are adjustable. In some examples, the liquid phase separated from the solids can be recirculated as input through an auxiliary inlet 134 and received as an input onto the belt separator 104.

The buffer tank separation and homogenization system 100 can also comprise additional valves, sensors, switches, actuators, pumps, and the like to facilitate the operation of the buffer tank separation and homogenization system 100. Further, the buffer tank separation and homogenization system 100 can comprise a controller to operate at least the valves, sensors, switches, actuators, and pumps of the system. The buffer tank separation and homogenization system 100 can also include vent outlets for one or more of the tanks described herein. For example, the solids tank 108 can have an air exhaust vent 172 (FIG. 3). Each vent outlet can be connected to a main gas exhaust line with a gas filter. For example, when the buffer tank separation and homogenization system 100 is a module in a single unit toilet system, the main exhaust line can also receive gas vented from other modules of the single unit toilet system. The gas filter can be configured so that the filtered gas release from the system is ISO 30500 compliant.

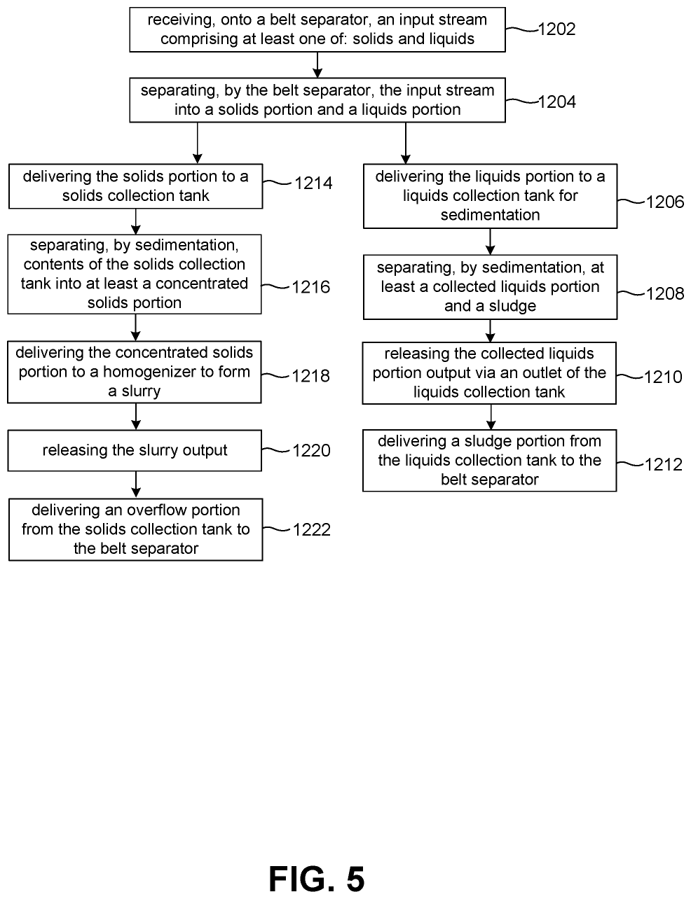

FIG. 5 shows an example method for buffer tank separation and homogenization as described herein. Although the method shown provides an example for producing an output for both the liquids tank and solids tank, steps can be added, omitted, or performed in a different sequence. For example, a single input stream can comprise a solids portion and a liquids portion. The method for processing the solids portion and liquids portions are shown separately, as liquids and solids outputs are processed in separate tanks, but the steps may occur simultaneously or in some other sequence.

At box 1202, the method can include receiving, onto a belt separator, an input stream comprising at least one of: solids and liquids. The buffer tank separation and homogenization system 100 can receive one or more input streams from separate sources. For example, a first input can be considered the green stream, as described herein, comprising mostly liquid with some solids, for example, toilet paper. In an example, a second input comprising at least feces and water can also be received separately via a second inlet. The second input can be considered the brown stream, as described herein, containing solids. For example, the second input can include feces, toilet paper, urine, and/or water. In some examples, a urine stream or yellow stream can be received via an auxiliary inlet. Although the urine stream is primarily urine, some trace amounts of toilet paper or other solids, if present, can be captured by the belt separator. As previously discussed, additional input streams can be received via one or more of the auxiliary inlets including: a sludge stream received from the liquids collection tank, an overflow stream received from the solids collection tank, a reject stream received from a liquids treatment system, a filtrate received from a feces treatment system, and a condensed effluent received from a feces treatment system. More than one input stream can be received separately or simultaneously.

At box 1204, the method can include separating, by the belt separator, the input stream into a solids portion and a liquids portion. For example, the toilet paper and other solids can be removed from an input stream that is mostly liquid with some solids. Similarly, the liquids can be removed from an input stream that is mostly solids with some liquids. The perforated belt of the belt separator can comprise pores configured to allow the liquids portion of the input stream to pass through to the liquids collection tank and to retain the solids portion on the perforated belt.

At box 1206, the method can include delivering the liquids portion to a liquids tank for sedimentation. The liquids portion of the input stream is allowed to pass through to the liquids collection tank. In some examples, at least some of the liquids portion of the input stream is directed to the liquids collection tank via a liquid deflector positioned beneath the belt separator.

At box 1208, the method can include separating, by sedimentation, at least a collected liquids portion and a sludge of settled solids. In the liquids collection tank, the solids are allowed to settle to the bottom of the liquids tank forming a collected liquids portion and a sludge. The liquids tank can include or be formed with a bottom wall that directs the separated solids toward a sludge outlet.

At box 1210, the method can include releasing a collected liquids portion from the liquids collection tank. In an example, the collected liquids portion output can be released natural overflow. In another example, the collected liquids portion output can be released via a valve system. For example, the collected liquids portion output can be delivered to a urine and wastewater treatment system. In some examples, the method can also include receiving a concentrate from a urine and wastewater treatment system via an auxiliary inlet. In some examples, at box 1212, the method can also include delivering, periodically, at least a portion of the contents of the liquids collection tank to the belt separator. For example, the sludge portion of the liquids collection tank can be delivered to the belt separator via an auxiliary port.

At box 1214, the method can include delivering the solids portion to a solids tank for sedimentation. The solids portion of the input stream can be retained on the perforated belt and conveyed to the solids collection tank. In some examples, at least some of the solids portion of the input stream can be removed from the belt using a stationary squeegee that scrapes the retained solids from the belt. For example, the solids portion can comprise feces and/or toilet paper from at least one input stream.

At box 1216, the method can include separating, by sedimentation, contents of the solids collection tank into at least a concentrated solids portion. The feces, toilet paper, and other solid particles can settle to the bottom of the solids collection tank, forming a concentrated solids portion.

At box 1218, the method can include delivering the concentrated solids portion to a homogenizer to form a slurry. The homogenizer can be a bladed macerator configured to transform the collected solids output in the solids tank into a uniform and homogenized slurry for transport to the treatment modules.

At box 1220, the method can include releasing the slurry output. For example, the slurry can be delivered to the slurry output to feces treatment system for further processing and removal or destruction of pathogens or contaminants. In some examples, the method can also include receiving a liquid effluent from a feces treatment system via an auxiliary inlet to the belt separator for separation. In some examples, at box 1222, the method can also include delivering, periodically, at least a portion of the contents of the solids collection tank to the belt separator or recirculating a portion of the solids tank via another inlet.

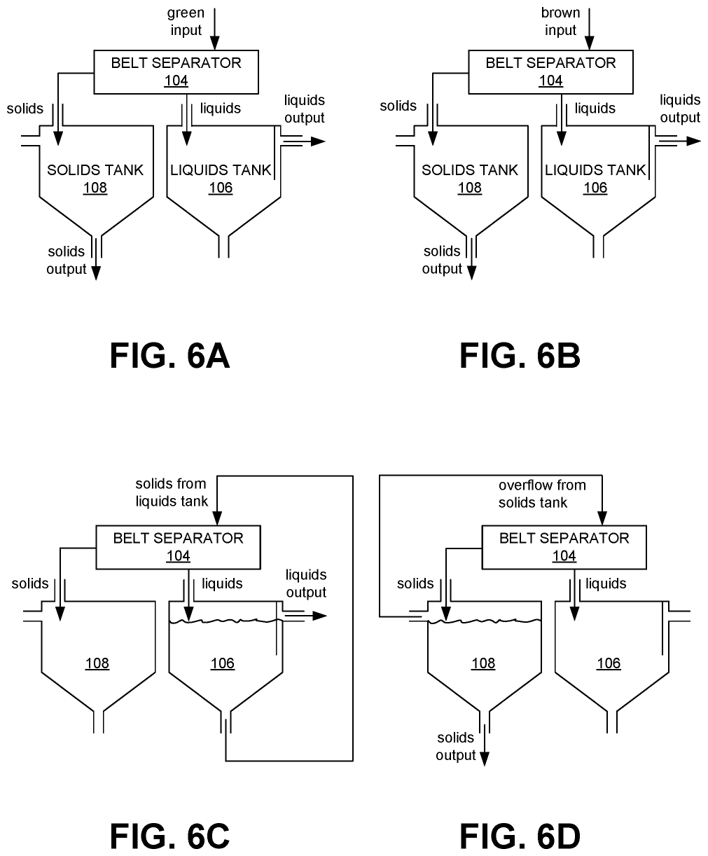

FIGS. 6A-6D further illustrate the operation of the buffer tank separation and homogenization system 100 by illustrating the flow within the system based on different waste events. The waste events can be determined by a user or detected by a sensor or simply directed to predetermined inlets of the buffer tank separation and homogenization system 100. As described herein, a green stream can be mostly liquid with some solids, a brown stream can be mostly feces and can also be mixed with other liquid and solid waste, and a yellow stream can be primarily urine.

Shown in FIG. 6A, for a urination event, a green stream can be received onto the belt separator 104 as the input stream. In some examples, a yellow stream can be received onto the belt separator 104. The liquids are delivered to the liquids tank 106 by passing through the perforated belt. As much toilet paper as possible is removed from the input stream by the belt separator 104 and delivered to the solids tank 108. After the solids have settled from the contents of the liquids tank, a collected liquids portion can be released. The liquids tank 106 can include a baffle or weir to help reduce the number of particulates that enter the liquids tank outlet 152.

In FIG. 6B, for a defecation event, a brown stream comprising feces, toilet paper, some urine, and some water can be received as the input stream. The liquids from the brown stream can be delivered through the perforated belt to the liquids tank 106. The solids from the brown stream can be delivered to the solids tank 108. The collected solids output can be delivered to the homogenizer and then to a feces treatment system for further processing.

FIG. 6C. illustrates an example of recirculating the contents of the liquids tank 106. There can be a buildup of solids in the liquids tank 106. Periodically, the sludge settled solids of the liquids tank 106 can be recirculated to the top of the belt separator 104 for a separation loop. For example, the liquids tank 106 can be recirculated about 2-3 times a day. The recirculation can improve the solid/liquid separation and prevent stagnation in the liquids tank 106.

FIG. 6D illustrates an example of a similar recirculation process for the solids tank 108. There can be a buildup of solids in the solids tank 108. Periodically, a portion of the contents of the solids tank 108 can be recirculated to the top of the belt separator 104 for a separation loop. For example, the solids tank 108 can be recirculated every 1-2 days. The recirculation can improve the solid/liquid separation and prevent stagnation in the solids tank 108.

The buffer tank separation and homogenization system 100 can be configured for use in various systems and applications. As discussed above, as an example, the buffer tank separation and homogenization system 100 can be a separation system configured for use in a stand-alone non-sewered toilet system. The buffer tank separation and homogenization system 100 can be configured to operate as part of and integrate with a single unit toilet system, such as a liquid treatment system, a solids treatment system, and/or another separation system.

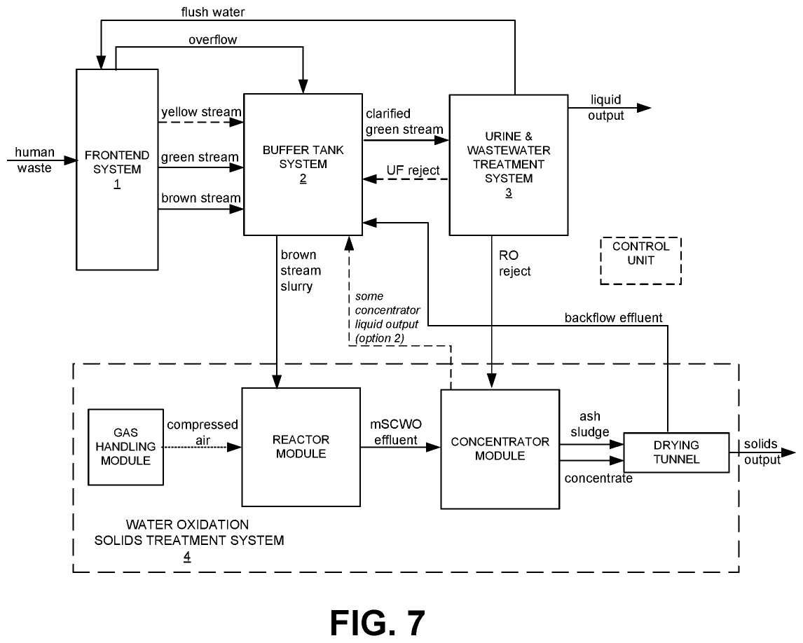

FIG. 7 illustrates an example schematic of a non-sewered single unit toilet system that includes a frontend system 1, a buffer tank system 2, a urine and wastewater treatment system 3, and a water oxidation solids treatment system 4. In this example, the buffer tank system 2 can comprise the buffer tank separation and homogenization system 100 described herein. For example, the frontend system 1 can be configured to capture human waste and to separate the mixed waste stream into at least one of a green stream and a brown stream. In some examples, a yellow stream can also be separated. The separated green, brown, and/or yellow streams can be further processed by a buffer tank system 2. The buffer tank system 2 can be configured to output a clarified green stream to a urine and wastewater treatment system 3 and a brown stream slurry to the water oxidation solids treatment system 4. Further, the buffer tank system 2 can receive input from one or more of the systems or modules of the single unit toilet system for additional processing. The non-sewered single unit toilet system can be configured to deliver a treated liquid output and a treated solids output. Clean water and/or treated water can be further used in the system for flush water in the frontend system 1 or used for processing in one or more of the systems or modules. The single unit toilet system can further comprise control unit comprising at least one controller for the operation of the system and/or one or more modules of the system, including valves, pumps, motors, sensors, and other devices.

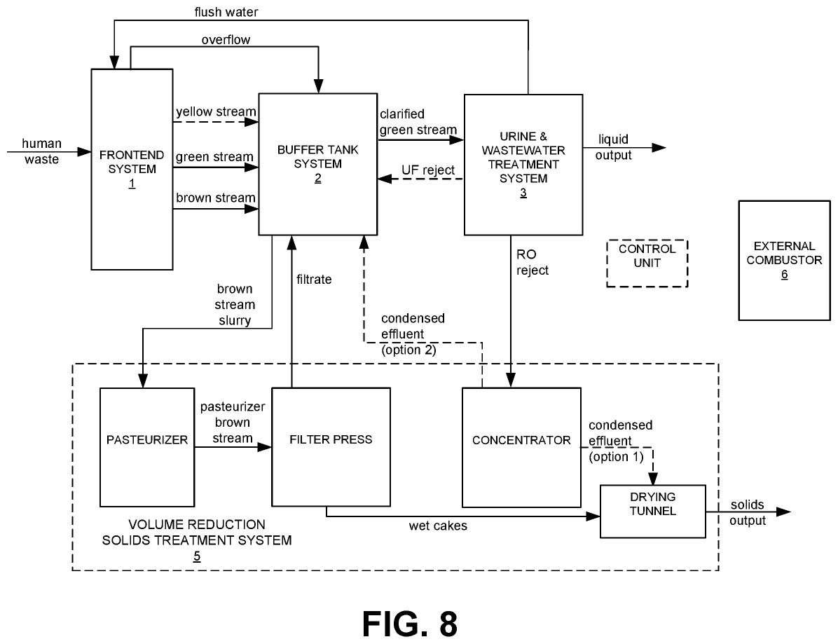

FIG. 8 illustrates another example schematic of a non-sewered single unit toilet system that includes a frontend system 1, a buffer tank system 2, a urine and wastewater treatment system 3, a volume reduction solids treatment system 5, and external combustor 6. In this example, a buffer tank system 2 can be a separation system that comprises the buffer tank separation and homogenization system 100 described herein. As shown the buffer tank system 2 can be modular and configured to adapt to another configuration of non-sewered single unit toilet system. Although there are similar modules in both FIG. 7 and FIG. 8, a different solids treatment module is shown in FIG. 8 as a volume reduction solids treatment system 5. Similar to FIG. 7, the frontend system 1 is configured to capture the human waste and to separate the mixed waste stream into at least one of a green stream and a brown stream. In some examples, a yellow stream can also be separated. The separated green, brown, and/or yellow streams can be further processed by a buffer tank system 2. The buffer tank system 2 can be configured to output a clarified green stream to a urine and wastewater treatment system 3 and a brown stream slurry to the volume reduction solids treatment system 5. The single unit toilet system can be configured to deliver a treated liquids output and a treated solids output. The single unit toilet system can further comprise a control unit comprising at least one controller for the operation of the system and/or one or more modules of the system, including valves, pumps, motors, sensors, and other devices. In this example, an external combustor 6 can also be part of the non-sewered single unit toilet system can be configured to receive the treated solids output.

### Aspects

The following list of exemplary aspects supports and is supported by the disclosure provided herein.

Aspect 1. A buffer tank separation system, comprising:
at least one inlet;
a liquids collection tank comprising a liquids outlet;
a solids collection tank comprising a solids outlet;
a belt separator comprising a perforated belt looped between two rollers, the belt separator positioned to receive an input stream via the at least one inlet onto the belt of the belt separator, the input stream comprising at least one of: solids and liquids, the belt separator configured to deliver a solids portion of the input stream to the solids collection tank and to deliver the liquids portion of the input stream to the liquids collection tank; and
a homogenizer connected to the solids outlet, the homogenizer configured to receive a collected solids portion output and form a uniform and homogenized slurry.

Aspect 2. The buffer tank separation system of aspect 1, wherein the perforated belt of the belt separator comprises pores configured to allow the liquids portion of the input stream to pass through to the liquids collection tank and to retain the solids portion on the perforated belt.

Aspect 3. The buffer tank separation system of aspect 1 or 2, further comprising a squeegee configured to remove the solids portion of the input stream from the perforated belt of the belt separator.

Aspect 4. The buffer tank separation system of any one of aspects 1-3, further comprising a liquid deflector positioned beneath the belt separator configured to direct at least some of the liquids portion of the input stream to the liquids collection tank.

Aspect 5. The buffer tank separation system of any one of aspects 1-4, wherein the liquids collection tank further comprises a sludge outlet and a bottom wall configured to direct a sludge stream to the sludge outlet, the sludge stream comprising solids settled from the liquids portion contained in the liquids collection tank.

Aspect 6. The buffer tank separation system of any one of aspects 1-5, wherein the solids collection tank further comprises an overflow outlet.

Aspect 7. The buffer tank separation system of any one of aspects 1-6, wherein the at least one inlet comprises a solids inlet configured to receive a mostly solids input stream comprising feces, the solids inlet comprising a chamber, an offset chamber inlet, and a chamber outlet, the chamber shaped such that the solids input stream received via the offset chamber inlet is directed toward an interior wall surface of the chamber to flow out the chamber outlet onto the belt separator.

Aspect 8. The buffer tank separation system of any one of aspects 1-7, wherein the at least one inlet comprises a liquids inlet configured to receive and direct a mostly liquids input stream onto the belt separator.

Aspect 9. The buffer tank separation system of any one of aspects 1-8, wherein the at least one inlet comprises one or more auxiliary input ports configured to receive at least one of: a urine stream comprising mostly urine, a sludge stream received from the liquids collection tank, an overflow stream received from the solids collection tank, a reject stream received from a liquids treatment system, a filtrate received from a feces treatment system, and a condensed effluent received from a feces treatment system.

Aspect 10. The buffer tank separation system of any one of aspects 1-9, further comprising a motor configured to drive at least one of the two rollers of the belt separator.

Aspect 11. A method for separating human waste using the buffer tank separation system of any one of aspects 1-10, the method comprising:
receiving, onto a belt separator, an input stream comprising at least one of: solids and liquids;
separating, by the belt separator, the input stream into a solids portion and a liquids portion;
delivering the liquids portion to a liquids collection tank for sedimentation;
delivering the solids portion to a solids collection tank;
forming, in a homogenizer, a uniform and homogenized slurry from a collected solids portion output from the solids collection tank.

Aspect 12. The method of aspect 11, wherein the input stream comprises at least one of: a mostly liquids input stream, a mostly solids input stream comprising feces, a urine stream comprising mostly urine, a sludge stream received from the liquids collection tank, an overflow stream received from the solids collection tank, a reject stream received from a liquids treatment system, a filtrate received from a feces treatment system, and a condensed effluent received from a feces treatment system.

Aspect 13. The method of aspect 12, wherein when the input stream is a mostly solids input stream comprising feces, the input stream is received via a solids inlet comprising a chamber, an offset chamber inlet, and a chamber outlet, the chamber shaped such that the solids input stream received via the offset chamber inlet is directed toward an interior wall surface of the chamber to flow out the chamber outlet onto the belt separator.

Aspect 14. The method of any one of aspects 11-13, wherein the belt separator comprises a perforated belt looped between two rollers, the belt separator positioned to receive an input stream comprising at least one of: solids and liquids, the input stream received via the at least one inlet onto the belt of the belt separator, the belt separator configured to deliver a solids portion of the input stream to the solids collection tank and to deliver the liquids portion of the input stream to the liquids collection tank.

Aspect 15. The method of any one of aspects 11-14, wherein the perforated belt of the belt separator comprises pores configured to allow the liquids portion of the input stream to pass through to the liquids collection tank and to retain the solids portion on the perforated belt.

Aspect 16. The method of any one of aspects 11-15, wherein delivering the solids portion to the solids collection tank comprising removing the solids portion of the input stream from the perforated belt of the belt separator with a squeegee.

Aspect 17. The method of any one of aspects 11-16, wherein delivering the liquids portion to a liquids collection tank for sedimentation comprises directing at least some of the liquids portion of the input stream to the liquids collection tank via a liquid deflector positioned beneath the belt separator.

Aspect 18. The method of any one of aspects 11-17, further comprising at least one of:
releasing the slurry to a feces treatment system; and
releasing a collected liquids portion from the liquids collection tank to a liquids treatment system.

Aspect 19. The method of any one of aspects 11-18, further comprising delivering a sludge portion of the liquids collection tank to the belt separator via a sludge outlet.

Aspect 20. The method of any one of aspects 11-19, further comprising delivering an overflow portion of the solids collection tank to the belt separator via an overflow outlet.

The features of the embodiments described herein are representative and, in alternative embodiments, certain features and elements can be added or omitted. It is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

1. A buffer tank separation system, comprising:
at least one inlet;
a liquids collection tank comprising a liquids outlet;
a solids collection tank comprising a solids outlet;
a belt separator comprising a perforated belt looped between two rollers, the belt separator positioned to receive an input stream via the at least one inlet onto the belt of the belt separator, the input stream comprising at least one of: solids and liquids, the belt separator configured to deliver a solids portion of the input stream to the solids collection tank and to deliver a liquids portion of the input stream to the liquids collection tank; and
a homogenizer connected to the solids outlet, the homogenizer configured to receive a collected solids portion output and form a uniform and homogenized slurry.

2. The buffer tank separation system of claim 1, wherein the perforated belt of the belt separator comprises pores configured to allow the liquids portion of the input stream to pass through to the liquids collection tank and to retain the solids portion on the perforated belt.

3. The buffer tank separation system of claim 1, further comprising a squeegee configured to remove the solids portion of the input stream from the perforated belt of the belt separator.

4. The buffer tank separation system of claim 1, further comprising a liquid deflector positioned beneath the belt separator configured to direct at least some of the liquids portion of the input stream to the liquids collection tank.

5. The buffer tank separation system of claim 1, wherein the liquids collection tank further comprises a sludge outlet and a bottom wall configured to direct a sludge stream to the sludge outlet, the sludge stream comprising solids settled from the liquids portion contained in the liquids collection tank.

6. The buffer tank separation system of claim 1, wherein the solids collection tank further comprises an overflow outlet.

7. The buffer tank separation system of claim 1, wherein the at least one inlet comprises a solids inlet configured to receive a mostly solids input stream comprising feces, the solids inlet comprising a chamber, an offset chamber inlet, and a chamber outlet, the chamber shaped such that the solids input stream received via the offset chamber inlet is directed toward an interior wall surface of the chamber to flow out the chamber outlet onto the belt separator.

8. The buffer tank separation system of claim 1, wherein the at least one inlet comprises a liquids inlet configured to receive and direct a mostly liquids input stream onto the belt separator.

9. The buffer tank separation system of claim 1, wherein the at least one inlet comprises one or more auxiliary input ports configured to receive at least one of: a urine stream comprising mostly urine, a sludge stream received from the liquids collection tank, an overflow stream received from the solids collection tank, a reject stream received from a liquids treatment system, a filtrate received from a feces treatment system, and a condensed effluent received from a feces treatment system.

10. The buffer tank separation system of claim 1, further comprising a motor configured to drive at least one of the two rollers of the belt separator.

11. A method for separating human waste using the buffer tank separation system of claim 1, the method comprising:
receiving, onto a belt separator, an input stream comprising at least one of: solids and liquids;
separating, by the belt separator, the input stream into a solids portion and a liquids portion;
delivering the liquids portion to a liquids collection tank for sedimentation;
delivering the solids portion to a solids collection tank;
forming, in a homogenizer, a uniform and homogenized slurry from a collected solids portion output from the solids collection tank.

12. The method of claim 11, wherein the input stream comprises at least one of: a mostly liquids input stream, a mostly solids input stream comprising feces, a urine stream comprising mostly urine, a sludge stream received from the liquids collection tank, an overflow stream received from the solids collection tank, a reject stream received from a liquids treatment system, a filtrate received from a feces treatment system, and a condensed effluent received from a feces treatment system.

13. The method of claim 12, wherein when the input stream is a mostly solids input stream comprising feces, the input stream is received via a solids inlet comprising a chamber, an offset chamber inlet, and a chamber outlet, the chamber shaped such that the solids input stream received via the offset chamber inlet is directed toward an interior wall surface of the chamber to flow out the chamber outlet onto the belt separator.

14. The method of claim 11, wherein the belt separator comprises a perforated belt looped between two rollers, the belt separator positioned to receive an input stream comprising at least one of: solids and liquids, the input stream received via the at least one inlet onto the belt of the belt separator, the belt separator configured to deliver a solids portion of the input stream to the solids collection tank and to deliver the liquids portion of the input stream to the liquids collection tank.

15. The method of claim 11, wherein the perforated belt of the belt separator comprises pores configured to allow the liquids portion of the input stream to pass through to the liquids collection tank and to retain the solids portion on the perforated belt.

16. The method of claim 11, wherein delivering the solids portion to the solids collection tank comprises removing the solids portion of the input stream from the perforated belt of the belt separator with a squeegee.

17. The method of claim 11, wherein delivering the liquids portion to a liquids collection tank for sedimentation comprises directing at least some of the liquids portion of the input stream to the liquids collection tank via a liquid deflector positioned beneath the belt separator.

18. The method of claim 11, further comprising at least one of:
releasing the slurry to a feces treatment system; and
releasing a collected liquids portion from the liquids collection tank to a liquids treatment system.

19. The method of claim 11, further comprising delivering a sludge portion of the liquids collection tank to the belt separator via a sludge outlet.

20. The method of claim 11, further comprising delivering an overflow portion of the solids collection tank to the belt separator via an overflow outlet.
